(19) United States
(12) Patent Application Publication
(10) Pub. No.: US 2026/0161553 A1
(43) Pub. Date: Jun. 11, 2026

(54) TECHNIQUE FOR OFFLOADING SNAPSHOTS OF HCI WORKLOADS TO ARCHIVAL STORAGE SERVICE

(71) Applicant: Nutanix, Inc., San Jose, CA (US)

(72) Inventors: Brajesh Kumar Shrivastava, Milpitas, CA (US); Deepak Narayan, Thiruvalla, Kerala (IN); Gurunath Gudi, Bangalore, Karnataka (IN); Shubham Shukla, Bhopal (IN)

(21) Appl. No.: 19/272,625

(22) Filed: Jul. 17, 2025

(30) Foreign Application Priority Data
Dec. 7, 2024 (IN) 202441096740

(51) Int. Cl. G06F 12/02; G06F 3/06; G06F 11/14

(52) U.S. Cl. CPC G06F 12/0253; G06F 3/0604; G06F 3/065; G06F 3/0679; G06F 11/1448; G06F 2212/7205

(57) ABSTRACT

A snapshot offloading technique increases dense node storage capacity limits for workloads executing on one of more nodes of a cluster by decoupling and replicating (offloading) one or more snapshots and associated metadata outside of the cluster directly to a snapshot storage service of an intermediary archival storage system. The snapshot storage service is illustratively a multi-cloud snapshot technology (MST) service configured to provide storage of large amounts of recovery points (i.e., snapshots) of application workloads on an object store. The snapshot is a right weight snapshot (RWS) that includes set of changes generated by a workload directed to a virtual disk (vdisk) and generated from an operations log on the cluster. Offloading of the RWS snapshots creates recovery point data and corresponding vdisk-level snapshots (and snapshot vdisks) directly on, e.g., a snapshot store of the MST service backed by an object store, while eliminating creation of those snapshot vdisks and corresponding garbage collection operations on the cluster.

### CROSS-REFERENCE TO RELATED APPLICATION

The present application claims the benefit of India Provisional Patent Application Serial No. 202441096740, which was filed on Dec. 7, 2024, by Brajesh Kumar Shrivastava, et al. for TECHNIQUE FOR OFFLOADING SNAPSHOTS OF HCI WORKLOADS TO ARCHIVAL STORAGE SERVICE, which is hereby incorporated by reference.

### BACKGROUND

### Technical Field

The present disclosure relates to point-in-time images or snapshots of data and, more specifically, to efficiently offloading snapshots from a computing cluster to an archival storage service.

### Background Information

A hyper-converged infrastructure (HCI) cluster of nodes may be configured to store data of workloads directed to one or more virtual disks (vdisks) and, often, may store large numbers of snapshots (including chains of snapshots) of those vdisks on the nodes of the HCI cluster. Storage of large numbers of snapshots may result in an increase of metadata (metadata bloat) corresponding to the snapshots. Metadata bloat may be further magnified during various operations such as snapshot chain severing and garbage collection, as well increased complexity of metadata needed to support storage of large numbers of snapshots. Ostensibly resources required to implement such metadata limits an overall storage capacity for the data per node of the HCI cluster. In addition, accessing data in the snapshot chain may require traversing many data structures to determine metadata needed to access the data, which can impact the performance of input/output (I/O) workflow of the workloads. Hence there is a limit on storage capacity per node for HCI clusters.

Further, storage of large numbers of vdisk snapshots on the HCI cluster also increases the size of the snapshot data set, which leads to more time needed for garbage collection (GC) scans, possibly resulting in degraded primary I/O performance if the GC lags workload processing. The impact of such vdisk snapshot storage adversely affects both the performance of data sets executing on the cluster, as well as scaling of node storage capacity limits.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of nodes interconnected as a cluster in a virtualized environment;

FIG. 2 is a block diagram of a virtualization architecture executing on a node to implement the virtualization environment;

FIG. 3 is a block diagram of a controller virtual machine of the virtualization architecture;

FIG. 4 is a block diagram of metadata structures used to map virtual disks (vdisks) of the virtualization architecture;

FIGS. 5A-5C are block diagrams of an exemplary mechanism used to create a snapshot of a vdisk;

FIG. 6 is a diagram illustrating an exemplary input/output path of the virtualization architecture;

FIG. 7 is a block diagram of a distributed operations log;

FIG. 8 is a data flow diagram illustrating replication of right weight snapshots from the cluster to a multi-cloud snapshot technology service of an intermediary archival storage system; and

FIG. 9 is a data flow diagram illustrating a connection break and reestablishment event.

### OVERVIEW

The embodiments described herein are directed to a snapshot offloading technique configured to support denser nodes (e.g., a node with a high storage capacity, such as 100 TB or more) for workloads executing on one or more nodes of a cluster by decoupling and replicating (offloading) one or more snapshots and associated metadata to a snapshot storage service of an intermediary archival storage system located either on the cluster or, in an illustrative embodiment, outside the cluster. The snapshot storage service is illustratively a multi-cloud snapshot technology (MST) service configured to provide storage of large numbers (amounts) of point-in-time images or recovery points (i.e., snapshots) of application workloads on an object store. Illustratively, the snapshot (e.g., generated on the cluster) is a right weight snapshot (RWS), i.e., an efficient log-based snapshot data structure having metadata referencing data in an operations log. The RWS includes a set of changes (change set) generated by a workload directed to a virtual disk (vdisk) and generated from the operations log (i.e., a sequential list of write operations embodied as an operations log, “oplog”) on the cluster. Offloading of the RWS snapshots creates recovery point data and corresponding vdisk-level snapshots (and snapshot vdisks) directly on, e.g., a snapshot store of the MST service backed by the object store, while eliminating creation of those snapshot vdisks and corresponding garbage collection operations on the cluster.

Advantageously, the snapshot offloading technique allows for a greater number of snapshots on fewer dense nodes as well as a smaller sized cluster, which leads to lower total cost of ownership of the cluster. Decoupling of the RWS snapshots from the local storage on the cluster to remote storage on the MST service substantially increases dense node storage capacity of the cluster to, e.g., a storage capacity limited only by the object store.

### DESCRIPTION

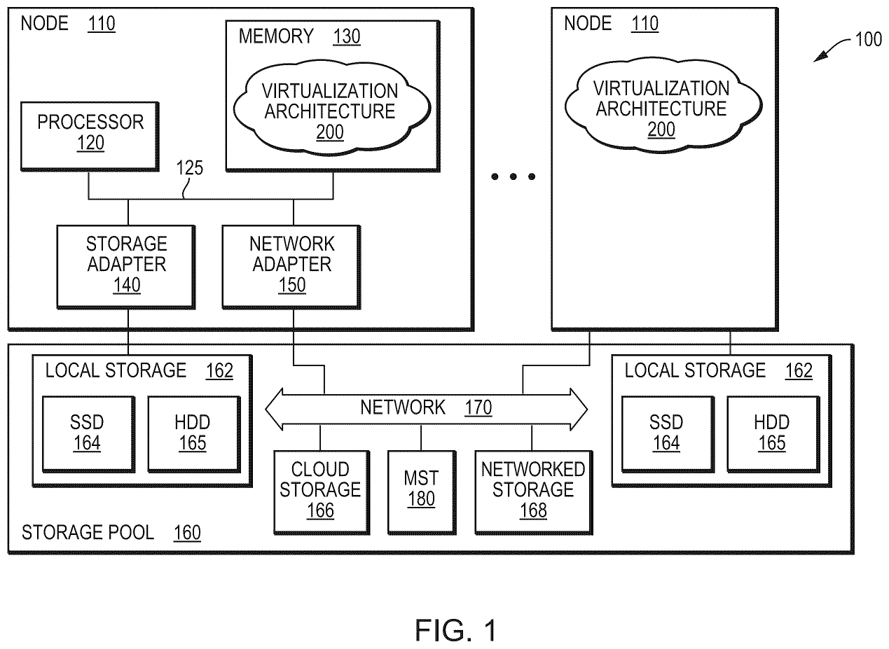

FIG. 1 is a block diagram of a plurality of nodes 110 interconnected as a logical or physical grouping of nodes such as, e.g., nodes of a cluster 100, and configured to provide compute and storage services for information, i.e., data and metadata, stored on storage devices of a virtualization environment. Each node 110 is illustratively embodied as a physical computer system (e.g., a compute node) having hardware resources, such as one or more processors 120, main memory 130, one or more storage adapters 140, and one or more network adapters 150 coupled by an interconnect, such as a system bus 125. The storage adapter 140 may be configured to access information stored on storage devices, such as solid-state drives (SSDs) 164 and magnetic hard disk drives (HDDs) 165, which are organized as local storage 162 and virtualized within multiple tiers of storage as a unified storage pool 160, referred to as scale-out converged storage (SOCS) accessible cluster-wide. To that end, the storage adapter 140 may include input/output (I/O) interface circuitry that couples to the storage devices over an I/O interconnect arrangement, such as a conventional peripheral component interconnect (PCI) or serial ATA (SATA) topology.

The network adapter 150 connects the node 110 to other nodes 110 of the cluster 100 over a network, which is illustratively an Ethernet local area network (LAN) 170. The network adapter 150 may thus be embodied as a network interface card having the mechanical, electrical and signaling circuitry needed to connect the node 110 to the LAN. In an embodiment, one or more intermediate stations (e.g., a network switch, router, or virtual private network gateway) may interconnect the LAN with network segments organized as a wide area network (WAN) to enable communication between the cluster 100 and a remote cluster over the LAN and WAN (hereinafter “network”) as described further herein. The multiple tiers of SOCS include storage that is accessible through the network, such as cloud storage 166 and/or networked storage 168, as well as the local storage 162 within or directly attached to the node 110 and managed as part of the storage pool 160 of storage objects, such as files and/or logical units (LUNs). The cloud and/or networked storage may be embodied as network attached storage (NAS) or storage area network (SAN) and include combinations of storage devices (e.g., SSDs and/or HDDs) from the storage pool 160. A multi-cloud snapshot technology (MST 180) service of an archival storage system provides storage of large numbers (amounts) of point-in-time images or recovery points (i.e., snapshots) of application workloads on an object store, which may be part of cloud storage 166. Communication over the network may be affected by exchanging discrete frames or packets of data according to protocols, such as the Transmission Control Protocol/Internet Protocol (TCP/IP) and the OpenID Connect (OIDC) protocol, although other protocols, such as the User Datagram Protocol (UDP) and the HyperText Transfer Protocol Secure (HTTPS) may also be advantageously employed.

The main memory 130 includes a plurality of memory locations addressable by the processor 120 and/or adapters for storing software code (e.g., processes and/or services) and data structures associated with the embodiments described herein. The processor and adapters may, in turn, include processing elements and/or circuitry configured to execute the software code, such as virtualization software of virtualization architecture 200, and manipulate the data structures. As described herein, the virtualization architecture 200 enables each node 110 to execute (run) one or more virtual machines that write data to the unified storage pool 160 as if they were writing to a SAN. The virtualization environment provided by the virtualization architecture 200 relocates data closer to the virtual machines consuming the data by storing the data locally on the local storage 162 of the cluster 100 (if desired), resulting in higher performance at a lower cost. The virtualization environment can horizontally scale from a few nodes 110 to a large number of nodes, enabling organizations to scale their infrastructure as their needs grow.

It will be apparent to those skilled in the art that other types of processing elements and memory, including various computer-readable media, may be used to store and execute program instructions pertaining to the embodiments described herein. Also, while the embodiments herein are described in terms of software code, processes, and computer (e.g., application) programs stored in memory, alternative embodiments also include the code, processes and programs being embodied as logic, components, and/or modules consisting of hardware, software, firmware, or combinations thereof.

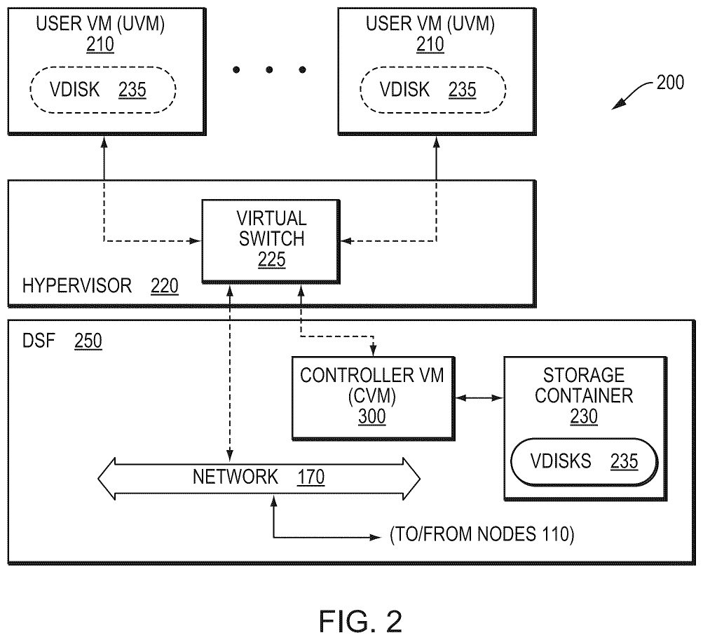

FIG. 2 is a block diagram of a virtualization architecture 200 executing on a node to implement the virtualization environment. Each node 110 of the cluster 100 includes software components that interact and cooperate with the hardware resources to implement virtualization. The software components include a hypervisor 220, which is a virtualization platform configured to mask low-level hardware operations from one or more guest operating systems executing in one or more user virtual machines (UVMs) 210 that run client software. The hypervisor 220 allocates the hardware resources dynamically and transparently to manage interactions between the underlying hardware and the UVMs 210. In an embodiment, the hypervisor 220 is illustratively the Nutanix Acropolis Hypervisor (AHV), although other types of hypervisors, such as the Xen hypervisor, Microsoft's Hyper-V, RedHat's KVM, and/or VMware's ESXi, may be used in accordance with the embodiments described herein.

Another software component running on each node 110 is a special virtual machine, called a controller virtual machine (CVM) 300, which functions as a virtual controller for SOCS. The CVMs 300 on the nodes 110 of the cluster 100 interact and cooperate to form a distributed system that manages all storage resources in the cluster. Illustratively, the CVMs and storage resources that they manage provide an abstraction of a distributed storage fabric (DSF) 250 that scales with the number of nodes 110 in the cluster 100 to provide cluster-wide distributed storage of data and access to the storage resources with data redundancy across the cluster. That is, unlike traditional NAS/SAN solutions that are limited to a small number of fixed controllers, the virtualization architecture 200 continues to scale as more nodes are added with data distributed across the storage resources of the cluster. As such, the cluster operates as a hyper-convergence infrastructure (HCI) architecture wherein the nodes provide both storage and computational resources available cluster wide.

The client software (e.g., applications) running in the UVMs 210 may access the DSF 250 using filesystem protocols, such as the network file system (NFS) protocol, the common internet file system (CIFS) protocol and the internet small computer system interface (iSCSI) protocol. Operations on these filesystem protocols are interposed at the hypervisor 220 and redirected (via virtual switch 225) to the CVM 300, which exports one or more iSCSI, CIFS, or NFS targets organized from the storage objects in the storage pool 160 of DSF 250 to appear as disks to the UVMs 210. These targets are virtualized, e.g., by software running on the CVMs, and exported as virtual disks (vdisks) 235 to the UVMs 210. In some embodiments, the vdisk is exposed via iSCSI, CIFS or NFS and is mounted as a virtual disk on the UVM 210. User data (including the guest operating systems) in the UVMs 210 reside on the vdisks 235 and operations on the vdisks are mapped to physical storage devices (SSDs and/or HDDs) located in DSF 250 of the cluster 100.

In an embodiment, the virtual switch 225 may be employed to enable I/O accesses from a UVM 210 to a storage device via a CVM 300 on the same or different node 110. The UVM 210 may issue the I/O accesses as a SCSI protocol request to the storage device. Illustratively, the hypervisor 220 intercepts the SCSI request and converts it to an iSCSI, CIFS, or NFS request as part of its hardware emulation layer. As previously noted, a virtual SCSI disk attached to the UVM 210 may be embodied as either an iSCSI LUN or a file served by an NFS or CIFS server. An iSCSI initiator, SMB/CIFS or NFS client software may be employed to convert the SCSI-formatted UVM request into an appropriate iSCSI, CIFS or NFS formatted request that can be processed by the CVM 300. As used herein, the terms iSCSI, CIFS and NFS may be interchangeably used to refer to an IP-based storage protocol used to communicate between the hypervisor 220 and the CVM 300. This approach obviates the need to individually reconfigure the software executing in the UVMs to directly operate with the IP-based storage protocol as the IP-based storage is transparently provided to the UVM.

For example, the IP-based storage protocol request may designate an IP address of a CVM 300 from which the UVM 210 desires I/O services. The IP-based storage protocol request may be sent from the UVM 210 to the virtual switch 225 within the hypervisor 220 configured to forward the request to a destination for servicing the request. If the request is intended to be processed by the CVM 300 within the same node as the UVM 210, then the IP-based storage protocol request is internally forwarded within the node to the CVM. The CVM 300 is configured and structured to properly interpret and process that request. Notably the IP-based storage protocol request packets may remain in the node 110 when the communication—the request and the response—begins and ends within the hypervisor 220. In other embodiments, the IP-based storage protocol request may be routed by the virtual switch 225 to a CVM 300 on another node of the same or different cluster for processing. Specifically, the IP-based storage protocol request may be forwarded by the virtual switch 225 to an intermediate station (not shown) for transmission over the network (e.g., WAN) to the other node. The virtual switch 225 within the hypervisor 220 on the other node then forwards the request to the CVM 300 on that node for further processing.

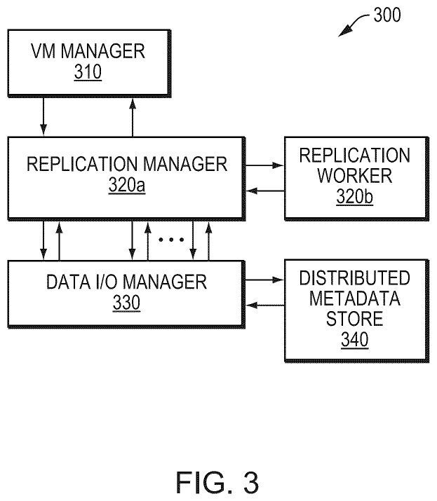

FIG. 3 is a block diagram of the controller virtual machine (CVM) 300 of the virtualization architecture 200. In one or more embodiments, the CVM 300 runs an operating system (e.g., the Acropolis operating system) that is a variant of the Linux® operating system, although other operating systems may also be used in accordance with the embodiments described herein. The CVM 300 functions as a distributed storage controller to manage storage and I/O activities within DSF 250 of the cluster 100. Illustratively, the CVM 300 runs as a virtual machine above the hypervisor 220 on each node and cooperates with other CVMs in the cluster to form the distributed system that manages the storage resources of the cluster, including the local storage 162, the networked storage 168, and the cloud storage 166. Since the CVMs run as virtual machines above the hypervisors and, thus, can be used in conjunction with any hypervisor from any virtualization vendor, the virtualization architecture 200 can be used and implemented within any virtual machine architecture, allowing the CVM to be hypervisor agnostic. The CVM 300 may therefore be used in variety of different operating environments due to the broad interoperability of the industry standard IP-based storage protocols (e.g., iSCSI, CIFS, and NFS) supported by the CVM.

Illustratively, the CVM 300 includes a plurality of processes embodied as a storage stack that may be decomposed into a plurality of threads running in a user space of the operating system of the CVM to provide storage and I/O management services within DSF 250. In an embodiment, the user mode processes include a virtual machine (VM) manager 310 configured to manage creation, deletion, addition and removal of virtual machines (such as UVMs 210) on a node 110 of the cluster 100. For example, if a UVM fails or crashes, the VM manager 310 may spawn another UVM 210 on the node. A replication manager 320a is configured to provide replication and disaster recovery capabilities of DSF 250. Such capabilities include migration/failover of virtual machines and containers, as well as scheduling of snapshots. In an embodiment, the replication manager 320a may interact with one or more replication workers 320b. A data I/O manager 330 is responsible for all data management and I/O operations in DSF 250 and provides a main interface to/from the hypervisor 220, e.g., via the IP-based storage protocols. Illustratively, the data I/O manager 330 presents a vdisk 235 to the UVM 210 in order to service I/O access requests by the UVM to the DFS. A distributed metadata store 340 stores and manages all metadata in the node/cluster, including metadata structures that store metadata used to locate (map) the actual content of vdisks on the storage devices of the cluster.

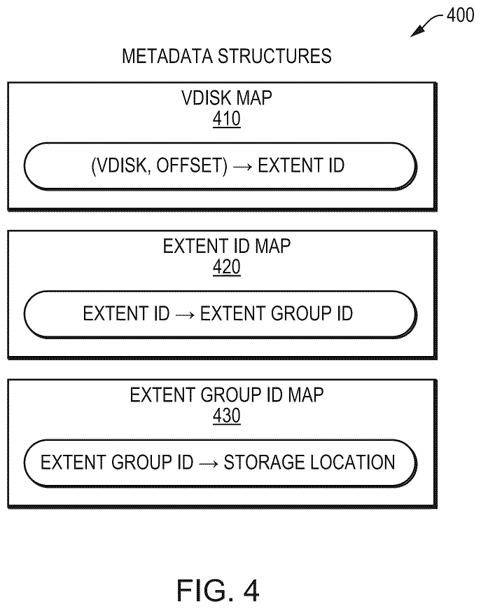

FIG. 4 is a block diagram of metadata structures 400 used to map virtual disks of the virtualization architecture. Each vdisk 235 corresponds to a virtual address space for storage exposed as a disk to the UVMs 210. Illustratively, the address space is divided into equal sized units called virtual blocks (vblocks). A vblock is a chunk of pre-determined storage, e.g., 1 MB, corresponding to a virtual address space of the vdisk that is used as the basis of metadata block map structures (maps) described herein. The data in each vblock is physically stored on a storage device in units called extents. Extents may be written/read/modified on a sub-extent basis (called a slice) for granularity and efficiency. A plurality of extents may be grouped together in a unit called an extent group. Each extent and extent group may be assigned a unique identifier (ID), referred to as an extent ID and extent group ID, respectively. An extent group is a unit of physical allocation that is stored as a file on the storage devices, which may be further organized as an extent store.

Illustratively, a first metadata structure embodied as a vdisk map 410 is used to logically map the vdisk address space for stored extents. Given a specified vdisk and offset, the logical vdisk map 410 may be used to identify a corresponding extent (represented by extent ID). A second metadata structure embodied as an extent ID map 420 is used to logically map an extent to an extent group. Given a specified extent ID, the logical extent ID map 420 may be used to identify a corresponding extent group containing the extent. A third metadata structure embodied as an extent group ID map 430 is used to map a specific physical storage location for the extent group. Given a specified extent group ID, the physical extent group ID map 430 may be used to identify information corresponding to the physical location of the extent group on the storage devices such as, for example, (1) an identifier of a storage device that stores the extent group, (2) a list of extent IDs corresponding to extents in that extent group, and (3) information about the extents, such as reference counts, checksums, and offset locations.

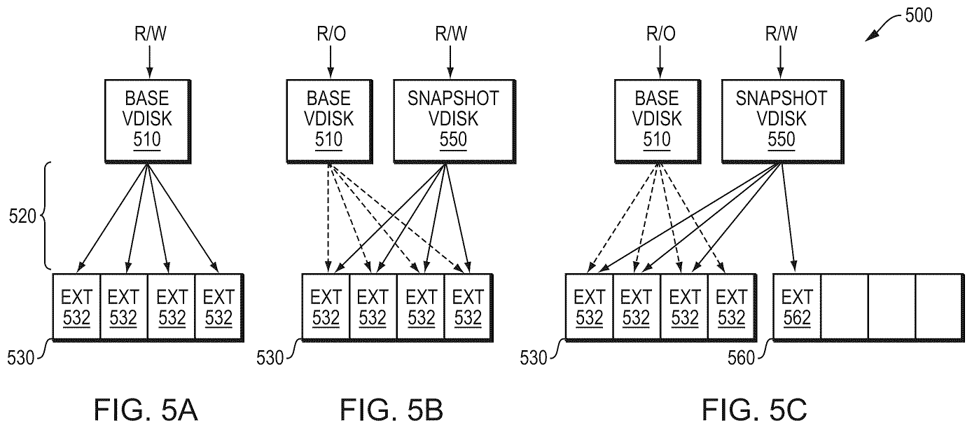

FIGS. 5A-5C are block diagrams of an exemplary mechanism 500 used to create a snapshot of a virtual disk. Illustratively, the snapshot is a point-in-time copy of a storage object, such as a vdisk, which may be created by leveraging an efficient low overhead snapshot mechanism, such as the redirect-on-write algorithm. As shown in FIG. 5A, the vdisk (base vdisk 510) is originally marked read/write (R/W) and has an associated block map 520, i.e., a metadata mapping with pointers that reference (point to) the extents 532 of an extent group 530 storing data of the vdisk on storage devices of DSF 250. Advantageously, associating a block map with a vdisk obviates traversal of a snapshot chain, as well as corresponding overhead (e.g., read latency) and performance impact.

To create the snapshot (vdisk-level snapshot), another vdisk (snapshot vdisk 550) is created by sharing the block map 520 with the base vdisk 510, as shown in FIG. 5B. This feature of the low overhead snapshot mechanism enables creation of the snapshot vdisk 550 without the need to immediately copy the contents of the base vdisk 510. Notably, the snapshot mechanism uses redirect-on-write such that, from the UVM perspective, I/O accesses to the vdisk are redirected to the snapshot vdisk 550 which now becomes the (live) vdisk and the base vdisk 510 becomes the point-in-time copy, i.e., an “immutable snapshot,” of the vdisk data. The base vdisk 510 is then marked immutable, e.g., read-only (R/O), and the snapshot vdisk 550 is marked as mutable, e.g., read/write (R/W), to accommodate new writes and copying of data from the base vdisk to the snapshot vdisk. In an embodiment, the contents of the snapshot vdisk 550 may be populated at a later time using, e.g., a lazy copy procedure in which the contents of the base vdisk 510 are copied to the snapshot vdisk 550 over time. The lazy copy procedure may configure DSF 250 to wait until a period of light resource usage or activity to perform copying of existing data in the base vdisk. Note that each vdisk includes its own metadata structures 400 used to identify and locate extents owned by the vdisk.

Another procedure that may be employed to populate the snapshot vdisk 550 waits until there is a request to write (i.e., modify) data in the snapshot vdisk 550 which is marked as mutable and becomes the live vdisk able to receive writes (as indicated above). Note that for clarity and continuity of discussion for elements 510 and 550, FIGS. 5A-C maintain names of the base vdisk 510 and snapshot vdisk 550 prior to their change of mutability in which vdisk 550 is marked immutable to become a snapshot and snapshot vdisk 550 is marked as mutable to become live disk. Depending upon the type of requested write operation performed on the data, there may or may not be a need to perform copying of the existing data from the base vdisk 510 (now immutable) to the snapshot vdisk 550 (now a mutable live vdisk). For example, the requested write operation may completely or substantially overwrite the contents of a vblock in the snapshot vdisk 550 (writable live vdisk) with new data. Since the existing data of the corresponding vblock in the base vdisk 510 will be overwritten, no copying of that existing data is needed and the new data may be written to the snapshot vdisk at an unoccupied location on the DSF storage (FIG. 5C). Here, the block map 520 of the snapshot vdisk 550 directly references a new extent 562 of a new extent group 560 storing the new data on storage devices of DSF 250. However, if the requested write operation only overwrites a small portion of the existing data in the base vdisk 510, the contents of the corresponding vblock in the base vdisk may be copied to the snapshot vdisk 550 and the new data of the write operation may be written to the snapshot vdisk to modify that portion of the copied vblock. A combination of these procedures may be employed to populate the data content of the snapshot vdisk.

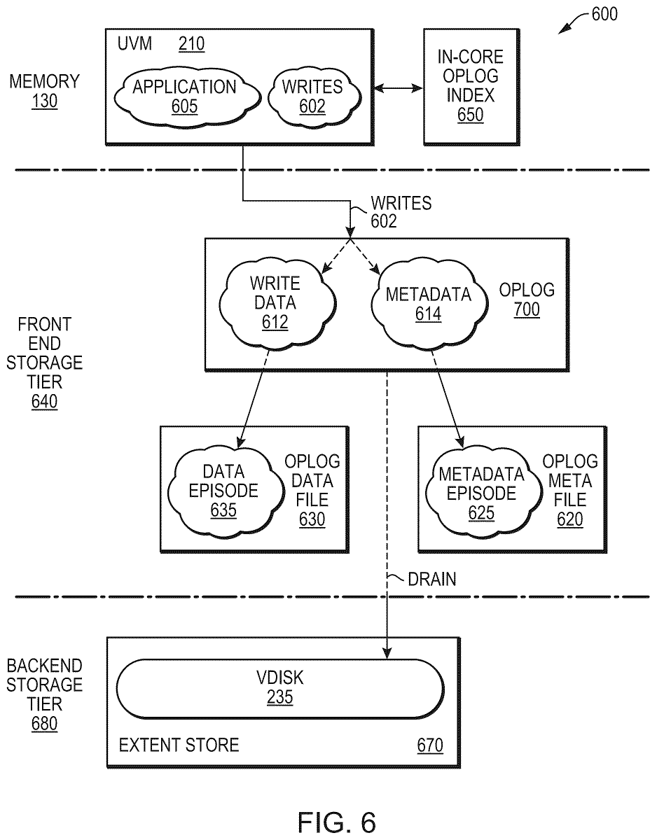

FIG. 6 is a diagram illustrating an exemplary input/output (I/O) path 600 of the virtualization architecture. An application 605 running in UVM 210 issues I/O accesses, such as write operations (writes) 602, to vdisk 235 exported from a backend storage tier 680 organized as an extent store 670 of DSF 250. The writes 602 (e.g., sequential and random writes) are temporarily stored (cached) at a log illustratively embodied as an operations log (oplog) 700, coalesced and sequentially drained to the extent store 670 (e.g., large block writes). The oplog 700 functions as a staging area to coalesce the writes 602 as a batch for periodic forwarding (draining) in a single operation to the extent store 670. In an embodiment, the oplog is persistently stored by the storage stack of the CVM 300 within a fast frontend storage tier 640 of DSF 250, e.g., on non-volatile memory express (NVMe) storage devices. Persistent storage of the oplog 700 on the frontend tier 640 enables fast acknowledgment of the writes 602 issued by application 605 running in UVM 210.

Illustratively, the oplog 700 caches (captures) the data associated with the writes (i.e., write data 612) and the metadata 614 describing the write data. The metadata 614 includes descriptors (e.g., pointers) to the write data 612 corresponding to virtual address regions, i.e., offset ranges, of the vdisk 235 and, thus, are used to identify the offset ranges of write data 612 for the vdisk 235 that are captured in the oplog 700. The captured metadata 614 of the oplog 700 is batched (collected) into one or more groups of predetermined size or number of entries, e.g., 1 MiB or 5000 entries, and recorded as one or more incremental images (metadata episodes 625) of metadata records in an oplog metafile 620 on the frontend storage tier 640. Similarly, the captured write data 612 may be grouped to a predetermined size or number of entries, e.g., 500 MB or 5000 entries, and recorded as one or more data episodes 635 of data in an oplog data file 630 on the frontend storage tier 640. Each episode of the oplog data and metafiles is marked with a timestamp identifier (ID) (i.e., a timestamp used as an identifier). In addition, each write 602 of the application workload serviced on the cluster has a logical timestamp that is recorded in the episode. The logical timestamp is used to order the writes when capturing a point-in-time image (snapshot) of the workload state.

In an embodiment, the episodes of the oplog data file 630 and oplog metafile 620 are replicated across one or more nodes 110 (e.g., a first node and a second node) of the cluster 100 according to a replication factor (RF) algorithm used for vdisk replication to ensure global redundancy protection and availability of data in the cluster. Illustratively, the data I/O manager 330 is a data plane process configured to perform a data and metadata replication procedure between, e.g., the first node and a data I/O manager “peer” on the second node. To that end, the data I/O manager 330 may employ remote direct memory access (RDMA) capabilities integrated in its code path used for vdisk replication in accordance with RF data protection to replicate the oplog data and metadata episodes across the nodes. Note that additional information may be stored on the distributed metadata store 340, such as (i) the node locations of the oplog metafiles (including RF replicas) for the replicated vdisk as well as (ii) IDs denoting beginning and ending (e.g., lowest and highest timestamps) of valid records in the episodes of those files. Durable storage of such information facilitates replication of the metadata episodes 625 from the first node to the second node.

To facilitate fast lookup operations of the offset ranges when determining whether write data 612 is captured in the oplog 610, a data structure, e.g., binary search tree such as a B (B+) tree, is embodied as an oplog index 650 configured to provide a state of the latest data at offset ranges of the vdisk 235. Notably, the oplog index 650 is stored in memory 130, i.e., dynamic random access memory (DRAM), of node 110 to provide an in-core representation of the oplog metafile 620 that may be examined to quickly determine the offset ranges for the latest data written to the vdisk 235. Instead of performing a sequential read operation (read) through the oplog metafile 620 to determine offset ranges for writes 602 captured in the oplog 700, the in-core oplog index 650 may be examined (i.e., searched) to quickly determine the offset ranges corresponding to the latest data written to the vdisk 235.

In an embodiment, the oplog 700 initially includes one episode (the initial episode) configured to receive (log) new writes 602. Upon reaching a threshold, the initial episode is closed and drained in due time (e.g., by the draining logic), newer episodes may be opened, and subsequent writes 602 are logged to records of those new episodes. Once its record contents are overwritten to a new episode or drained, the initial (oldest) episode may be deleted to perform garbage collection (GC). Deleting an episode frees up space in oplog; however, as noted, the oplog is a log-structured data structure that requires episodes be deleted in sequence (order), e.g., the oldest episode deleted first, even if a newer (subsequent) episode is “inactive” i.e., all records are either flushed or overwritten to newer episodes. That is, an episode can be deleted only when all the data in it (as well as all the data in older episodes) has been flushed to the extent store or has been overwritten in subsequent episodes or a combination of the two. The ordered sequence of deletion facilitates recovery, i.e., replay of all records of episodes in order.

In an embodiment, the records of the episode may be organized as vblock numbers per user write offset range of a vdisk, e.g., the vdisk address space is divided into 1 MB vblock offset ranges. For example, a first record may be designated vblock 0 with a user write offset range (offset range) of 0-1 MB, a second record may be designated vblock 1 with an offset range of 1 MB-2 MB, and a third record may be designated vblock 10 with an offset range of 10 MB-11 MB. The latest (newest) write data for the vblocks of the oldest episode are collected (and their newer records nullified) from all of the episodes and flushed (drained) to the extent store 670 in one I/O transaction. For instance, write data from a 0-4K offset range may be collected from episode 1, write data from a 4K-8K offset range may be collected from episode 2, and write data from a 16K-32K offset range may be collected from episode 3 for a single flushing transaction to the extent store 670. Draining of latest write data in this manner reduces the number of updates to the metadata store 340 by coalescing and draining of the latest write data of particular vblocks to the extent store in a single transaction.

In an embodiment, CVM 300, DSF 250 and MST 180 may cooperate to provide support for vdisk-level snapshots (“vdisk snapshots”). For example, CVM 300, DSF 250 and MST 180 may cooperate to process an application workload (e.g., data processed by application 605) for local storage on a vdisk 235 of the cluster 100 (operating as an on-premises HCI cluster) as one or more generated snapshots that may be further processed for replication to an external repository. The replicated snapshot data may be backed up from the cluster 100 to the external repository at the granularity of a vdisk. The external repository may be a backup vendor or, illustratively, cloud-based storage 166, such an object store.

In an embodiment, MST 180 is a snapshot storage service that provides storage of large numbers (amounts) of point-in-time images or recovery points (i.e., snapshots) of application workloads on an object store of an intermediary archival storage system. To that end, the MST service 180 is configured to store and retrieve data efficiently from the object store, and may be deployed as a component for hybrid multi-cloud data backup and restore environments that provide flexibility to store data in a highly available, resilient, and ubiquitous object store. Data services/processes of MST 180 may execute on a computing platform (cluster) of one or more nodes 100 including, e.g., processor 120, memory 130, and one or more network adapters 150 and storage adapters 140, at any location and is generally “stateless” as all data/metadata are stored on the object store. MST 180 also facilitates transferring of a protected entity (e.g., an application) to an on-premises cluster, such as HCI cluster 100, from the cloud in case of a disaster.

Illustratively, MST 180 utilizes an index data structure for efficient retrieval of data from one of a substantial number of snapshots stored (maintained) in the object store. Indexing of the index data structure is configured according to extents of a vdisk defined as contiguous, non-overlapping, variable-length regions of the vdisk generally sized for convenience of object stores in archival storage systems (e.g., Amazon AWS S3 storage services, Google Cloud Storage, Microsoft Azure Blob Storage, and the like). Each snapshot maintained in the object store is associated with a corresponding index data structure and may include incremental changes to a prior snapshot that may reference a prior index data structure associated with the prior snapshot. Notably, metadata required to access data of vdisk snapshots is fully hydrated (e.g., present and accessible) in all vdisk snapshots at MST 180.

In an embodiment, metadata is stored on the distributed metadata store 340 of the cluster 100. Storage of large amounts of metadata, as well as the complexity of that metadata, adversely affects performance of I/O workload requests issued by the application 605 executing on the cluster 100 because the metadata may not be fully hydrated in vdisk snapshots on the cluster, requiring scanning of the vdisk snapshots of a snapshot chain to access metadata needed to read data of the snapshots. For example, if metadata required to locate certain data is not present in a particular vdisk snapshot, the snapshot chain may be scanned (walked) to access the required metadata from one or more other snapshots in the chain. In addition, the data/metadata contents of vdisks created on the cluster 100 are eventually garbage collected (GC) by a GC engine (GC engine logic) on the cluster, which determines the (old) data to delete from the cluster. The GC engine logic operations may be reduced on the cluster 100 by limiting creation of vdisks and associated snapshots from steady-state workflow processing, i.e., by limiting the GC load. This, in turn, may increase the useful storage capacity of the cluster nodes for storing “live” active data and allowing support for denser nodes.

The embodiments described herein are directed to a snapshot offloading technique configured to increase dense node storage capacity (e.g., a node having a high storage capacity such as 100 TB or more) for workloads executing on one or more nodes of a cluster by decoupling and replicating (offloading) one or more snapshots and associated metadata of the cluster directly to a snapshot storage service of an intermediary archival storage system located outside the cluster. The snapshot storage service is illustratively a multi-cloud snapshot technology (MST) service configured to provide storage of large numbers (amounts) of point-in-time images or recovery points (i.e., snapshots) of application workloads on an object store. Illustratively, the snapshot is a right weight snapshot (RWS), i.e., an efficient log-based snapshot data structure having metadata referencing data in an operations log. To that end, the RWS includes a set of changes (change set) generated by a workload directed to a virtual disk (vdisk) and generated from the operations log (i.e., a sequential list of write operations embodied as an operations log, “oplog”) on the cluster. Offloading of the RWS snapshots creates recovery point data and corresponding vdisk-level snapshots (and snapshot vdisks) directly on, e.g., a snapshot store of the MST service backed by an object store to substantially reduce the garbage collection (GC) load on the GC engine executing on the cluster by eliminating creation of those snapshot vdisks and corresponding GC operations on the cluster.

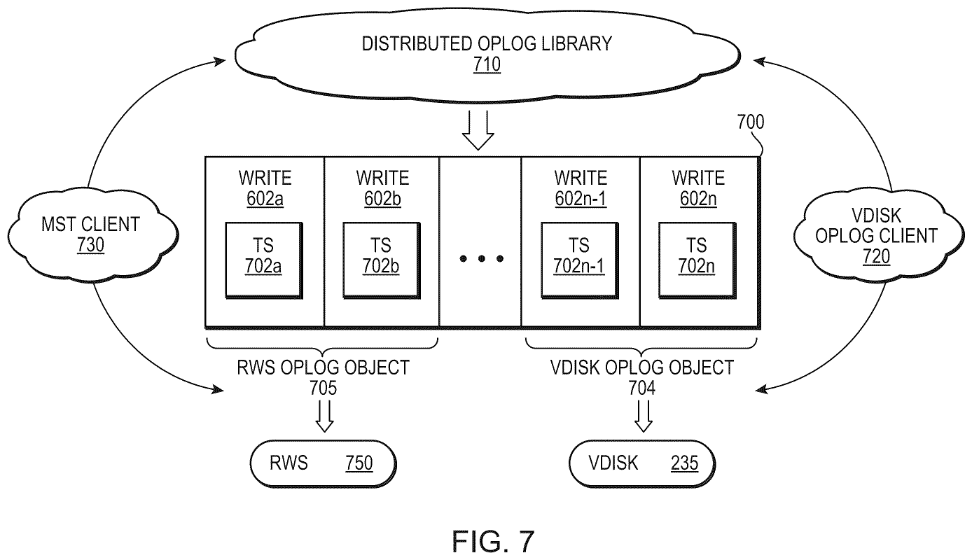

In an embodiment, the oplog 700 is a distributed oplog that is managed by a distributed oplog library. FIG. 7 is a block diagram of a distributed log 700 that may be advantageously used with the embodiments described herein. The distributed oplog library 710 executes on one or more nodes of the cluster to manage the distributed oplog 700 by eliminating tight coupling between the oplog and a vdisk 235 and allowing a plurality of entities (e.g., distributed oplog clients) to share the distributed oplog 700 to perform, e.g., replication. Writes 602 (e.g., writes 602a, 602b, 602n-1, 602n) issued by application 605 and having logical timestamps 702 (e.g., TS 702a, TS 702b, TS 702n-1, TS 702n) may be appended to, e.g., metadata episodes 625 of the distributed oplog 700. The logical timestamps (TS) 702 are used to order the writes 602 so that if there are redundant (overlapping) writes for a specific offset range to a vdisk 235 managed by a distributed oplog client, the distributed oplog library 710 may apply/serve the latest write in response to an I/O access (e.g., read) at that offset range. The distributed oplog library 710 also obviates the need to perform garbage collection (GC).

In an embodiment, sharing of the distributed oplog 700 among various distributed oplog clients may be implemented through the use of distributed oplog objects. For example, the distributed oplog library 710 implements a log, wherein new entries (i.e., records) are appended to the end of the log. The log is split into multiple chunks called episodes, wherein each episode has a metafile and a data file. The data file stores user data while the metafile stores corresponding metadata. The distributed oplog 700 may be apportioned across the HCI cluster 100 on storage devices (e.g., up to 12 SSDs) of each node 110 so that the storage capacity of the storage devices is shared among the oplog objects. The distributed oplog library 710 allows creation of as many independent logs as required, where each log is implement and managed as a distributed log object.

The distributed oplog clients may utilize the distributed oplog library 710 by referring to (referencing) the logs at logical (record) timestamps of the distributed oplog 700. For example, multiple oplog clients may register to a log and each client may register to a portion of the log. The log portion may be represented as a closed range (e.g., record timestamp X to record timestamp Y) or an open range (e.g., record timestamp X to “infinity” or all records starting from X). One log may be used per vdisk snapshot chain, such that each vdisk 235 in the chain uses the same log. Each vdisk in the chain may register (refer) to different exclusive portions of the log via its own client (e.g., vdisk oplog client 720). A leaf vdisk refers to an open range (e.g., X to infinity). Once some data is drained to the extent store 670, the vdisk 235 moves the start of the range (X′) forward. Upon generation of a snapshot, the vdisk snapshot refers to a closed range range (X′ to Y), whereas the new leaf vdisk starts referring to Y+1 to infinity.

One example of a distributed oplog client is a vdisk oplog client 720 that is configured to manage content of the oplog for a vdisk 235 as represented by a vdisk-based distributed oplog object (vdisk oplog object 704). The vdisk oplog client 720 may register the vdisk oplog object 704 with the distributed oplog library 710 through the use of a logical timestamp range. As new writes 602 are issued with the timestamps (TS) 702, the writes are appended and recorded (e.g., as records) in metadata episode 625 of the distributed oplog 700. Once data is drained (flushed) from the data episode 635 of the distributed oplog 700 to the extent store 670 (i.e., the distributed file system 250 of the cluster), there may be some records that are no longer needed by the vdisk oplog client 720 and its vdisk 235. The vdisk oplog client 720 may delete references to those records once it has drained the data from the episode 635 to the extent store 670.

In an embodiment, the snapshot offloading technique provides another client (e.g., MST client 730) of the distributed oplog 700. The MST client 730 is configured to execute on one or more nodes of the cluster to (i) track new writes directed to a logical entity, such as a vdisk, (ii) create (generate) and track generation of one or more snapshots of the vdisk using one or more distributed oplog objects of the distributed oplog, and (iii) cooperate with the distributed oplog library to replicate the snapshot to MST 180. Illustratively, the snapshot created by the MST client 730 is a RWS snapshot 750, which is similar to a light-weight snapshot (LWS) in that both snapshots are essentially change sets generated by workloads generated from the distributed oplog 700 but differ with respect to the frequency of snapshot generation. Both LWS and RWS snapshots are generated using logical timestamp ranges of the oplog objects in the distributed oplog; however, LWS is generated locally and may be replicated to remote cluster (e.g., of a disaster recovery site) at a “high frequency” (e.g., every few seconds), whereas RWS snapshot 750 is generated and stored locally until drained to the MST but receives its data from the oplog 700 stored at the HCI cluster and is generated at a generally slower user-defined frequency (e.g., every hour). Although the underlying oplog infrastructure (i.e., data structures) are the same for each type of snapshot, a snapshot vdisk 235 is created locally (at the HCI cluster 100 typically with an hourly frequency) as a basis for generating the LWS. In contrast, a remote snapshot vdisk (remote disk) is created remotely (at the MST 180), and not locally, as a basis for generating the RWS snapshot 750.

In an embodiment, the distributed oplog library 710 may cooperate with the MST client 730 to create one or more remote disks of a snapshot store on MST 180 for RWS snapshots generated at the distributed log 700 without creating a snapshot vdisk on the HCI cluster 100. The RWS snapshot 750 is represented as an RWS-based distributed oplog object (RWS oplog 705) in the distributed oplog 700. The MST client 730 may register the RWS oplog object 705 with the distributed oplog library 710 through the use of a logical timestamp range of writes recorded (e.g., as records) in an episode (e.g., metadata episode 625) associated with the RWS object 705. For example, the MST client 730 may register to the log and an open range, e.g., (A to infinity). Once some data (or the entire RWS) is replicated to the MST cluster, the MST client moves its start range forward.

A user may configure a policy to generate a snapshot (e.g., a RWS 750) periodically (e.g., every hour). The MST client 730 may generate the RWS snapshot (e.g., periodically) referencing data within the distributed oplog 700 by marking a range of logical timestamps 702 associated with writes 602 (write records) of the RWS oplog object 705 as representing the RWS. For example, the MST client 730 may mark the range of timestamps X to Y so as to generate RWS Z and save the markings as metadata (e.g., a metadata record) representative of the RWS Z. Illustratively, the RWS snapshot 750 is embodied as the metadata record specifying that all write records from logical timestamp X (which is typically the next logical timestamp from the end of a previous RWS) to logical timestamp Y as associated with RWS Z.

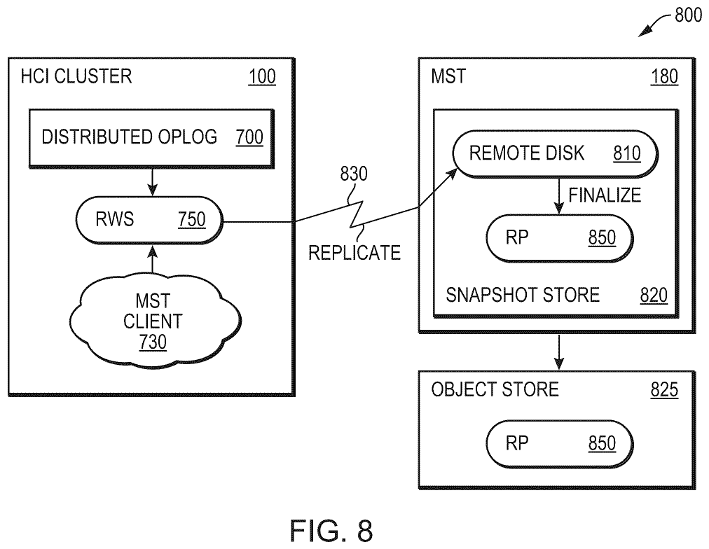

FIG. 8 is a data flow diagram illustrating replication of RWS from the HCI cluster to the MST service of the intermediary archival storage system. Upon completion of RWS snapshot generation from the distributed oplog 700, the MST client 730 may begin copying (replicating) the data associated with RWS snapshot 750 to a snapshot store 820 (represented by one or more remote disks 810) on MST 180. The MST client 730 may maintain its own timestamp to record, e.g., replication progress. The MST client 730 transfers (replicates) the data associated with the RWS 750 on MST 180 by determining the records associated with the offset range of the RWS oplog object 705, coalescing any records having overwrites to that range, and replicating (transmitting) the resulting data to MST 180.

In an embodiment, RWS replication may be performed in accordance with the same procedure for draining data from the oplog to extent store; however instead of draining data to the DFS 250 of the cluster, data is drained to the MST. For example, RWS replication may involve reading the oldest episode in the RWS 750 and determining all the vblocks (e.g., 1 MiB chunks of the vdisk) written in that episode. The entire data for each vblock in the RWS 750 is read and multiple writes to the same vblock may be ordered and coalesced. The data associated with the RWS 750 is transmitted to MST 180 on a per vblock basis although, in another embodiment, the data for multiple vblocks may batched (aggregated) and transmitted in a single transmission to prevent extra overhead of MST handling of many small writes or overwrites. This procedure continues for all episodes associated with the RWS 750. Note that episodes may be deleted as soon as all data for an episode is replicated to MST 180 or after all data for the entire RWS is replicated.

Once all the coalesced data for the RWS 750 has been replicated, the MST service 180 organizes the replicated data for storage in one or more data objects on an object store 825 and finalizes the RWS 750 (snapshot) by creating an index data structure for the snapshot (including the associated data objects). The snapshot may then become (part of) a recovery point (RP) 850 for storage on the object store 825. For example, the RP 850 may include 10 UVMs, wherein each UVM may include 5 vdisks. Each vdisk may be represented as an RWS oplog object 705 in the distributed oplog 700. The RP 850 encapsulates the entire state for all of the vdisks (e.g., 50 vdisks) included in the 10 UVMs as finalized by MST 180. In an embodiment, the MST service 180 creates one or more remote disks 810 as placeholders of the snapshot store 820 for storing the replicated RWS snapshot 750. After the remote disks 810 are remotely hydrated (filled) with metadata drained from the distributed oplog 700 on the HCI cluster 100, MST 180 finalizes the RWS snapshots 750 of those vdisks as RP 850 and stores the RP 850 on object store 825, after which the data (e.g., episodes) at the HCI cluster may be deleted.

For example, assume writes 602 of a workload processed by UVM application 605 executing on the HCI cluster 100 are directed to the 50 vdisks of the 10 UVMs and logged at the distributed oplog 700. A decision is rendered to create one or more RWS snapshots 750. The MST client 730 keeps track of the logical timestamps 702 of the writes 602 by referring to a portion of the log written by the vdisk oplog client (e.g., a relevant logical timestamp range, such as A to infinity). The MST client 730 then generates RWS snapshots 750 of the RWS oplog object 705 (e.g., within relevant logical timestamp ranges) at a point-in-time for, e.g., vdisk1 between logical timestamps L1-L2, vdisk2 between logical timestamps L3-L4, etc. Once the timestamps are marked (captured), the actual data for the RWS snapshots are replicated to MST 180.

The MST service 180 receives the replicated RWS data at one or more remote disks 810 (e.g., target RWS vdisks created for the VMs) and finalizes the VMs as RWS snapshots of RP 850 in response to a finalization command sent from the MST client 730. The MST service 180 determines that there are 50 RWS snapshots S1-S50 for the 10 UVMs that need finalization as RP 850 and creates an index for each snapshot. The 50 RWS snapshots are then encapsulated as a control plane RP structure for the 10 UVMs in accordance with a disk configuration for each vdisk/snapshot. The disk configuration includes information about the root node for each index of each vdisk/snapshot. A top-level RP configuration identifies the encapsulated 10 UVMs as including vdisks/snapshots S1-S50, wherein each vdisk/snapshot has disk configuration information about the root node of its index. Note that the MST has the capability of finalizing an individual vdisk/snapshot as a RP 850 or a collection (grouping) of vdisks/snapshots as a top-level RP 850.

In an embodiment, replication of the snapshot data and finalization of the snapshot occurs in accordance with an atomic transaction protocol. Notably, there is no snapshot vdisk created at the HCI cluster 100 for the RWS snapshot 750 used in RWS replication; instead, according to the technique, a remote disk 810 is created at MST 180 for the RWS snapshot 750. The MST client 730 replicates the data of the RWS snapshot 750 (represented by the logical timestamp range) to MST 180, which seeds (fills) the remote disk 810 with the replicated data of the RWS snapshot 750. Once all the data is replicated, the MST service 180 finalizes the RWS snapshot 750 by creating an index for the snapshot. The MST client 730 then deletes the local references to the data replicated to the RWS at the distributed oplog 700 by, e.g., cooperating with the distributed oplog library 710 to delete references to the episodes belonging to the RWS snapshot 750.

### Steady-State Workflow

In an embodiment, the MST client 730 may generate RWS snapshots 750 at the user-defined frequency, wherein each RWS snapshot 750 includes records bounded by a logical timestamp range. The MST client may coalesce (i.e., aggregate or order overwrites) data of the RWS snapshot 750 prior to replicating that data to MST 180. Once replication of the RWS snapshot 750 from the HCI cluster 100 to MST completes, the MST client 730 may de-register its interest (reference) in the logical timestamp range with distributed oplog library 710. In the meantime, the vdisk oplog client 720 may drain its associated vdisk 235 and de-register its interest in the logical timestamp range of its vdisk oplog object 704 with the distributed oplog library 710. The library 710 may then clean-up (delete and GC) those ranges from the distributed oplog 700.

In an embodiment, an instant recovery feature may be used to effect recovery by creating a vdisk 235 that is backed by an external data source (e.g., MST 180 and object store 825) that references (points to) a RP 850 in the object store 825. The vdisk 235 is created at the HCI cluster 100 and I/O operations (reads, writes) are directed to the vdisk 235 and fetched remotely from the RP 850 as needed. The data of the vdisk 235 is hydrated from the RP 850 in a background process with read requests to data ranges not yet hydrated (filled) from the RP 850 fetched on-demand from the RP 850.

### Connection Break Between HCI Cluster and MST

In an embodiment, the HCI cluster 100 at which RWS snapshots 750 are generated and MST 180 may operate (run) at different locations or sites. Accordingly, an aspect of the snapshot offloading technique is directed to stateful resumption of RWS data replication when the MST appears unavailable, such as a situation (event) where either MST 180 is offline (fails) or a network connection 830 between the HCI cluster 100 and MST 180 fails (e.g., a connection break between the HCI cluster and MST). Initially, the MST client 730 at the HCI cluster 100 continues attempting replication of RWS snapshots 750 to MST 180 for a pre-determined period of time (e.g., 10 mins). After the time period elapses, a connection break and reestablishment event may be triggered (initiated).

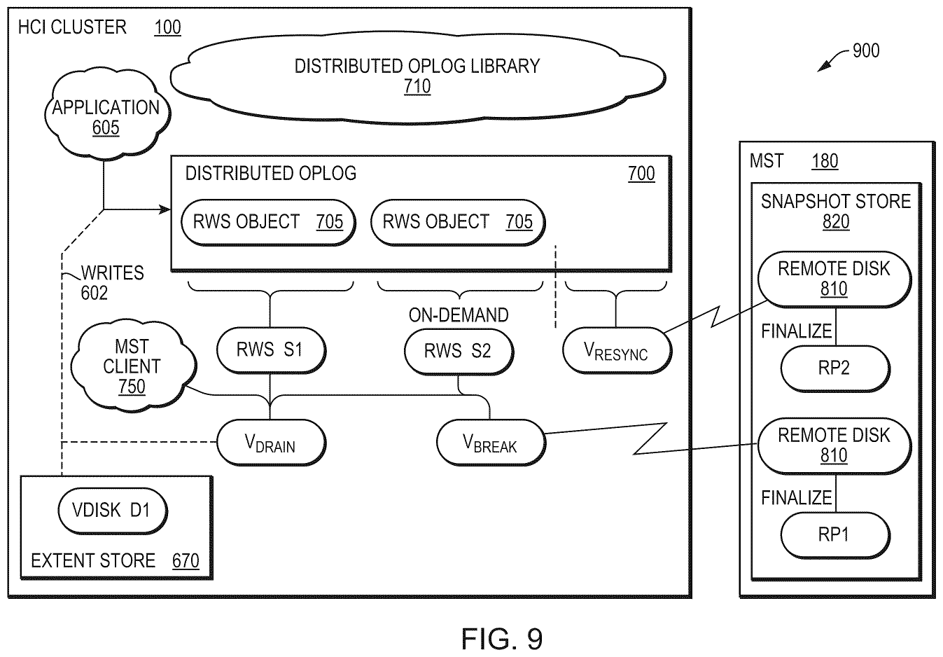

FIG. 9 is a data flow diagram illustrating a connection break and reestablishment event 900. Assume replication of a RWS snapshot S1 (for vdisk D1) generated from the distributed oplog 700 by MST client 730 is underway (in progress) to the MST service 180. New writes 602 issued by application 605 to vdisk D1 are logged (recorded) at the distributed oplog 700. However, insufficient time has passed for the user-defined frequency trigger to generate a new RWS snapshot. Upon initiation of a connection break phase of the event 900, another RWS snapshot S2 is generated on-demand by the MST client 730. New snapshots V_{BREAK} and V_{DRAIN} are also generated at the HCI cluster, e.g., in the DFS 250. The V_{BREAK} snapshot is a vdisk snapshot generated to store a point-in-time image (e.g., checkpoint) representing a state of the vdisk at the time of the connection break.

In an embodiment, the MST client 730 drains the distributed oplog contents of all RWSs that have yet to be replicated to MST 180 (e.g., the as yet un-replicated RWS snapshots S1, S2) to V_{DRAIN}. That is, the contents of V_{DRAIN} include un-replicated logical timestamp records of S1, S2, represented as episodes of RWS objects 705 in the distributed oplog 700; these oplog contents are drained to V_{DRAIN}. Illustratively, draining of the record contents of S1, S2 to V_{DRAIN} is similar to replicating of those contents to a remote disk 810 in MST 180, e.g., draining organizes the contents of the distributed oplog 700 as S1, S2 in a single vdisk V_{DRAIN}. Alternatively, such draining may generate two (2) vdisks V_{DRAIN1}, V_{DRAIN2} for the RWS snapshots S1, S2 respectively, i.e., a vdisk per RWS snapshot. Notably, V_{DRAIN} is created to free-up storage space in the distributed oplog 700 by draining the data to the extent store 670. S1 and S2 can then be deleted to reclaim oplog storage space.

During the time that MST 180 is unavailable (during the connection break phase), the user (administrator) may instruct generation of vdisk snapshots at the same frequency as the RWS snapshots. Writes 602 issued by application 605 are thus continually recorded at the distributed oplog 700; however, as the new writes 602 are recorded, the storage capacity of the distributed oplog may be exhausted (oplog space is constrained). Accordingly, the episodes of S1, S2 may be deleted by the distributed oplog library 710.

### Connection Re-Established Between HCI Cluster and MST

Upon connection re-establishment between the HCI cluster 100 and MST 180, a resynchronization phase of the event 900 is initiated wherein a vdisk snapshot V_{RESYNC} is generated at the HCI cluster to allow a return to the normal, steady-state workflow where RWS snapshots 750 are generated in accordance with the user-defined frequency policy. Data drained and recorded from V_{DRAIN} to V_{BREAK} are replicated to MST 180, which creates a remote disk 810 as a placeholder for a snapshot and finalizes the snapshot as a RP1. Data from V_{BREAK} to V_{RESYNC} are replicated to MST 180 by, e.g., calculating differences (diffs) between two vdisk-based snapshots and replicating those diffs from the HCI cluster 100 to MST 180 as recovery point RP2. If multiple vdisk snapshots exist within V_{BREAK} to V_{RESYNC}, the diffs between consecutive snapshots are generated and replicated, e.g., as RPs. During diff replication, any new RWS snapshots 750 may be generated and replicated to MST 180 in parallel with the diff replication. However, the RPs can only be finalized in order at MST 180 so that the diff replication transfer must finish/complete before the RWS snapshots are finalized (i.e., finalization of the RPs must wait for completion of the diff replication). Local vdisk snapshots as well as RWS snapshots (i.e., logical timestamp records in the distributed oplog) may be cleaned-up (GC/deleted) as soon as they are replicated.

In an embodiment, recovery points are generated in response to (i) a connection break, i.e., V_{BREAK} as RP1 and (ii) connection re-establishment, i.e., V_{RESYNC} as RP2. The recovery points RP1 and RP2 cooperate to address/handle the connection break and reestablishment event 900 (e.g., triggered by a failure). The V_{BREAK} snapshot is used as a checkpoint to establish a point-in-time image (RP1) of the state of the vdisk at the time of the connection break, which state is replicated to MST 180. The V_{RESYNC} snapshot is a point-in-time image (RP2) of the state of the vdisk at the time of the connection reestablishment, which is also replicated to MST 180.

Advantageously, the snapshot offloading technique leads to lower total cost of HCI cluster ownership by reducing local storage needs on the nodes of the HCI cluster, particularly for snapshots that may be offloaded to remote storage. Decoupling of the RWS snapshots from the local storage on the cluster to remote storage on the MST service substantially increases dense node storage capacity of the HCI cluster to, e.g., a storage capacity limited only by object store capacity.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks and/or electronic memory) having program instructions executing on a computer system, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
logging write operations (writes) having logical timestamps issued by an application executing on one or more compute nodes of a cluster at a distributed operations log (oplog) of the cluster prior to forwarding the writes to a persistent store of the cluster, wherein the writes are directed to a virtual disk (vdisk) represented as a distributed oplog object;
generating one or more snapshots of the distributed oplog object using ranges of the logical timestamps associated with the writes of the distributed oplog object;
replicating data of the writes associated with the ranges of the logical timestamps of the one or more snapshots to a cloud-based snapshot technology (MST) service, wherein the replicated writes are drained from the oplog; and
finalizing the one or more snapshots at the MST service upon completion of the replication of the data of the writes without creating a vdisk snapshot at the cluster for each of the one or more snapshots to reduce a garbage collection (GC) load on a GC engine executing on the cluster.

2. The method of claim 1 wherein the replication of the data further comprises coalescing the data and sorting data overwrites according to the timestamps.

3. The method of claim 2 wherein the one or more snapshots are log-based with metadata referencing data in an operations log (right weight snapshots) and wherein generating the one or more right weight snapshots further comprises creating a remote disk at the MST service as a placeholder to receive the replicated data of the one or more right weight snapshots.

4. The method of claim 1 wherein generating the one or more snapshots comprises initiating the generation of the one or more snapshots periodically or on-demand by a MST client executing on the compute node and cooperating with a distributed oplog library.

5. The method of claim 1 further comprising registering the distributed oplog object with a distributed oplog library according to the logical timestamp range of writes.

6. The method of claim 1 wherein the distributed oplog objects include episodes accumulating metadata records of the writes associated with the logical timestamp range of writes.

7. The method of claim 1 wherein a vdisk oplog client is configured to manage contents of the oplog for the vdisk.

8. The method of claim 1 wherein replicating the one or more snapshots comprises:
creating one or more remote disks at the MST as placeholders for storing the replicated data of the one or more snapshots; and
hydrating the remote disk with metadata of the snapshot drained from the distributed oplog.

9. The method of claim 1 wherein the one or more snapshots are log-based with metadata referencing data in an operations log (right weight snapshots) and wherein finalizing the one or more right weight snapshots at the MST service comprises creating an index data structure for the snapshot.

10. The method of claim 1 further comprising de-registering interest in the logical timestamp range of the oplog object with a distributed oplog library.

11. A non-transitory computer readable medium including program instructions for execution on a processor of a node for a cluster, the program instructions configured to:
log write operations (writes) having logical timestamps issued by an application executing on the node at a distributed operations log (oplog) of the cluster prior to forwarding the writes to a persistent extent store of the cluster, wherein the writes are directed to a virtual disk (vdisk) represented as a distributed oplog;
generate one or more snapshots of the distributed oplog object using ranges of the logical timestamps associated with the writes of the distributed oplog object;
replicate data of the writes associated with the ranges of the logical timestamps of the one or more snapshots to a cloud-based snapshot technology service (MST), wherein the replicated writes are drained from the oplog; and
finalize the one or more snapshots at the MST upon completion of the replication of the data of the write operations without creating a vdisk snapshot at cluster for each of the one or more snapshots to reduce a garbage collection (GC) load on a GC engine executing on the cluster.

12. The non-transitory computer readable medium of claim 11, wherein the replication of the data further comprises coalescing the data and sorting data overwrites according to the timestamps.

13. The non-transitory computer readable medium of claim 11, wherein the one or more snapshots are log-based with metadata referencing data in an operations log (right weight snapshots) and wherein the program instructions configured to generate the one or more right weight snapshots are further configured to create a remote disk at the MST service as a placeholder to receive the replicated data of the one or more right weight snapshots.

14. The non-transitory computer readable medium of claim 11, wherein the program instructions configured to generate the one or more snapshots are further configured to initiate the generation of the one or more snapshots periodically or on-demand by a MST client executing on the compute node and cooperating with a distributed oplog library

15. The non-transitory computer readable medium of claim 11, wherein the program instructions are further configured to register the distributed oplog object with a distributed oplog library according to the logical timestamp range of writes.

16. The non-transitory computer readable medium of claim 11, wherein the distributed oplog objects include episodes accumulating metadata records of the writes associated with the logical timestamp range of writes.

17. The non-transitory computer readable medium of claim 11, wherein a vdisk oplog client is configured to manage contents of the oplog for the vdisk.

18. The non-transitory computer readable medium of claim 11, wherein the program instructions are further configured to:
create one or more remote disks at the MST as placeholders for storing the replicated data of the one or more snapshots; and
hydrate the remote disk with metadata of the snapshot drained from the distributed oplog.

19. The non-transitory computer readable medium of claim 11, wherein the one or more snapshots are log-based with metadata referencing data in an operations log (right weight snapshots) and wherein finalizing the one or more right weight snapshots at the MST service comprises creating an index data structure for the snapshot.

20. A system comprising:
a network connecting one or more nodes of a cluster, the node having a processor configured to execute program instructions to:
log write operations (writes) having logical timestamps issued by an application executing on the node at a distributed operations log (oplog) of the cluster prior to forwarding the writes to a persistent extent store of the cluster, wherein the writes are directed to a virtual disk (vdisk) represented as a distributed oplog;
generate one or more snapshots of the distributed oplog object using ranges of the logical timestamps associated with the writes of the distributed oplog object;
replicate data of the writes associated with the ranges of the logical timestamps of the one or more snapshots to a cloud-based snapshot technology service (MST), wherein the replicated writes are drained from the oplog; and
finalize the one or more snapshots at the MST upon completion of the replication of the data of the write operations without creating a vdisk snapshot at cluster for each of the one or more snapshots to reduce a garbage collection (GC) load on a GC engine executing on the cluster.
